(19) United States
(12) Patent Application Publication
(10) Pub. No.: US 2007/0138679 A1
(43) Pub. Date: Jun. 21, 2007

(54) APPARATUS AND METHOD FOR CONTINUOUSLY BENDING FLEXIBLE DEVICE

(76) Inventors: Yan-Rung Lin, Pingtung County (TW); Shie-Chang Jeng, Pingtung County (TW); Chi-Chang Liao, Tainan City (TW); Jow-Tsong Shy, Hsinchu City (TW); Yu-Hung Lien, Taipei City (TW); Cheng-Chung Chen, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,372

(22) Filed: Mar. 20, 2006

(30) Foreign Application Priority Data
Dec. 20, 2005 (TW) 94145221

(51) Int. Cl. B29C 53/00

(52) U.S. Cl. 264/40.1; 264/339; 425/169; 425/DIG. 44; 425/440

(57) ABSTRACT

A method for continuously bending a flexible device is suitable in use for inspecting a physical property of a flexible device in different curvatures fast. The method includes bending the flexible device to make a part of it be in an intended curvature. And it is at an inspection position. Further, the flexible device is moved, so as to make at least a portion of the flexible panel to pass the inspection position with the intended curvature. Further, the invention also provides an apparatus implemented with the foregoing method. The flexible device can be an inspected device itself or an inspected device held by a flexible carrier.

### CROSS-REFERENCE TO RELATED APPLICATION

This application claims the priority benefit of Taiwan application serial no. 94145221, filed on Dec. 20, 2005. All disclosure of the Taiwan application is incorporated herein by reference.

### BACKGROUND OF THE INVENTION

1. Field of Invention

The present invention relates to a flexible device inspection technology. More particularly, the present invention relates to a method and apparatus for continuously bending a flexible device.

2. Description of Related Art

The design and developing trend of portable electronic products and consumptive electronic products is light, thin, and compact. Flexible electronic products made of new plastic materials are integrated with optical, electric and sensing functions. In addition to satisfying the forgoing conditions, with these flexible electronic products made of new flexible materials, a new application field for electronic products can be developed. Also it is ergonomic, easy to put on, soft and safe, flexible in bending, and suitable for multi-functional digital mobile electronic products, for example, flexible displays.

However, for a flexible device, its physical properties may alter when bending. Herein, physical properties includes the performance properties of the device, or any physical effect or device performance etc. which may alter when bending the device, for example, the display property of a flexible display. In the phase of research and development, the applicable scope of the product can be acquired from the performance of the flexible device at different curvatures, or the material can be evaluated by the property of the function film thereon which alters along with changes in curvature. During mass production, semi-manufactured products or finished products should go through certain inspections to pick out defective ones, where the bending test is one of the inspection methods employed.

In view of the above, if properties in different curvatures are tested, the device should be bent to an intended curvature. Preferably, every part of the device is bent to an intended curvature, and the curvatures alter continuously.

### SUMMARY OF THE INVENTION

One object of the invention is to provide a method for continuously bending a flexible device, to continuously bend inspected devices with a curvature for quick inspection in an overall area.

Another object of the invention is to provide an apparatus for continuously bending a flexible device, to continuously bend inspected devices with a curvature for quick inspection in an overall area.

The invention provides a method for continuously bending a flexible device, applicable to continuously bending a flexible device for inspecting a physical property in different curvatures. The method includes bending the flexible device to generate an intended curvature at an inspection position thereon. Further, the flexible device is moved, so as to make at least one portion of the flexible device pass the inspection position with the intended curvature.

With respect to the method for continuously bending a flexible device according to the preferred embodiments of the invention, the above intended curvature is deduced from a material property and geometrical and physical quantities of the flexible device, or obtained from a measurement reference datum (look-up table), or a direct measurement.

With respect to the method for continuously bending a flexible device according to the preferred embodiments of the invention, the above step of moving the flexible device includes disposing an output portion for continuously outputting the flexible device in the direction towards the inspection position and a receiving portion for continuously receiving the bent flexible device.

With respect to the method for continuously bending a flexible device according to the preferred embodiments of the invention, the above step of moving the flexible device includes respectively fixing both ends of the flexible device on different support portions and moving the two support portions in opposite directions.

With respect to the method for continuously bending a flexible device according to the preferred embodiments of the invention, the step of bending the flexible device includes the steps as follows.

A first support member and a second support member are disposed at a first position and a second position respectively, for clamping and bending the flexible device. The first and second positions of the first and second support members can be adjusted in a relative lateral direction, so as to generate the intended curvature.

With respect to the method for continuously bending a flexible device according to the preferred embodiments of the invention, the forgoing flexible device is an inspected device itself or a carrier for holding an inspected device.

The invention further provides an apparatus for continuously bending a flexible device, applicable to continuously bending a flexible device for inspecting a physical property in different curvatures. The apparatus includes a first support member disposed at a first position, and a second support member disposed at a second position. The flexible device is bent to generate an intended curvature at a position, for example a bending tip at an inspection position, by the support of the first and second support members, in accordance with the first position, the second position, and a material property of the flexible device. Furthermore, the apparatus includes a transmission system, for driving the flexible device to move continuously, and making at least one portion of the flexible device pass the inspection position with the intended curvature.

With respect to the apparatus for continuously bending a flexible device according to the preferred embodiments of the invention, a measurement unit can be further included, for directly measuring the curvature of the device.

With respect to the apparatus for continuously bending a flexible device according to the preferred embodiments of the invention, the transmission system includes an output member, for continuously outputting the flexible device in a first direction towards the inspection position, and a receiving member, for continuously receiving the output flexible device in a second direction.

With respect to the apparatus for continuously bending a flexible device according to the preferred embodiments of the invention, the transmission system includes two support members and the transmission system which is capable of respectively moving supports on the two support members, so as to respectively fix both ends of the flexible device on different supports, and move the two supports in opposite directions.

With respect to the apparatus for continuously bending a flexible device according to the preferred embodiments of the invention, at least one of the first support member or the second support member supports the flexible device through a first clamp and a second clamp for clamping at both surfaces of the flexible device.

With respect to the apparatus for continuously bending a flexible device according to the preferred embodiments of the invention, at least one of the first support member or the second support member includes a surface for contacting with the flexible device.

With respect to the apparatus for continuously bending a flexible device according to the preferred embodiments of the invention, at least one of the first or second support members includes at least one roller, for supporting the flexible device.

With respect to the apparatus for continuously bending a flexible device according to the preferred embodiments of the invention, at least one of the first or second support members includes at least one roller with the function of transmitting the flexible device.

With respect to the apparatus for continuously bending a flexible device according to the preferred embodiments of the invention, the first position and the second position of the first and second support members can be adjusted in lateral directions according to the intended curvature.

With respect to the apparatus for continuously bending a flexible device according to the preferred embodiments of the invention, the flexible device is an inspected device itself or a carrier for holding an inspected device.

In general, the above invention is characterized in that a first support member and a second support member are adopted to bend a flexible device, so as to generate an inspection region with an intended curvature at an inspection position; and the flexible device can be moved for making at least one portion of the flexible device pass the inspection position with the intended curvature. As such, the inspected device can be made to have the intended curvature. With the property of other measurement apparatuses inspecting a stripe area on the device each time and through moving the inspected device, a quick inspection in an overall area can be achieved.

In order to the make the aforementioned and other objects, features and advantages of the present invention comprehensible, preferred embodiments accompanied with figures are described in detail below.

### BRIEF DESCRIPTION OF THE DRAWINGS

FIG. 1 depicts the schematic structural top view of a flexible device according to the invention.

FIG. 2 depicts the schematic structural cross-sectional view of the flexible device of FIG. 1.

FIG. 3 depicts the schematic view of the state of the flexible device when bent.

FIG. 4 depicts the schematic structural top view of the apparatus for continuously bending a flexible device according to one embodiment of the invention.

FIG. 5 depicts the schematic structural top view of the apparatus for continuously bending a flexible device according to another embodiment of the invention.

FIG. 6 depicts the schematic structural top view of the apparatus for continuously bending a flexible device according to another embodiment of the invention.

FIG. 7 depicts the schematic structural top view of the apparatus for continuously bending a flexible device according to another embodiment of the invention.

FIG. 8 depicts the schematic structural top view of the apparatus for continuously bending a flexible device according to another embodiment of the invention.

FIG. 9 depicts the schematic perspective view of the structure of the apparatus for continuously bending a flexible device according to another embodiment of the invention.

FIG. 10 depicts the schematic structural view of the support member according to another embodiment of the invention.

### DESCRIPTION OF EMBODIMENTS

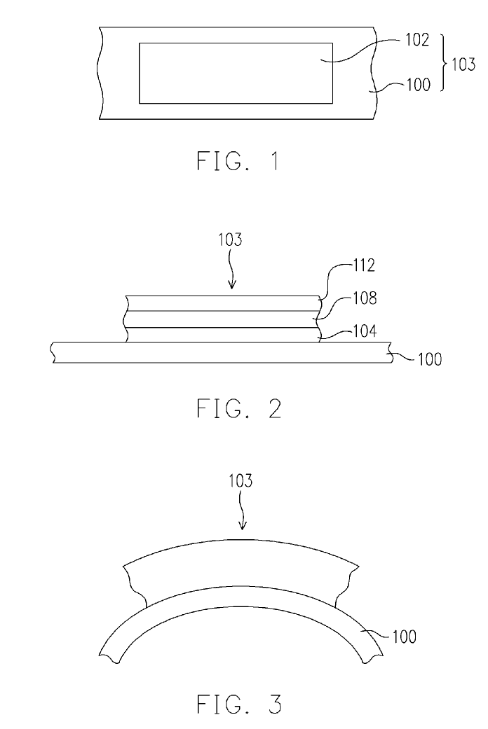

FIG. 1 depicts the schematic structural top view of a flexible device suitable according to the invention. The flexible device of the invention is, for example, a flexible device including a device substrate 100 and a flexible device structure 102 on the substrate 100. FIG. 2 depicts the schematic structural sectional view of the flexible device of FIG. 1. The flexible device structure 102 formed on the device substrate 100 includes, for example, a lower electrode layer 104, a display layer 108, an upper electrode layer 112, and so on. However, the structural layers are not intended to limit the flexible device structure 102. In other words, the flexible device 103 is an inspected device which can be a complete device structure, or a part of a functional structural layer, or the like, i.e., any inspected flexible device, no matter finished or half-finished, can be applied.

Furthermore, from another point of view, the bent device can be a carrier itself on which the inspected flexible device 103 is attached.

FIG. 3 depicts the schematic view of the state of the flexible device when bent. As the device is in a bent state, some physical properties may be changed. The invention can provide a simple method and apparatus for continuously bending the flexible device, so as to inspect the physical property of the inspected device 103 in different curvatures or the dynamic effect under a bent state, with an intended curvature.

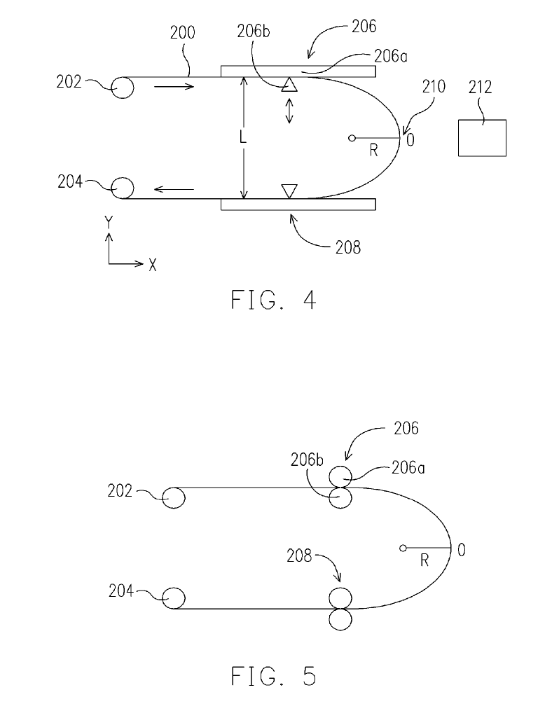

FIG. 4 depicts the schematic structural top view of the apparatus for continuously bending a flexible device according to one embodiment of the invention. In FIG. 4, the XY coordinate is a reference for illustration. According to the moving mechanism of the flexible device 200, the longitudinal direction refers to the direction along the X axis, while the lateral direction refers to the direction along the Y axis. The apparatus for continuously bending a flexible device according to the embodiment is applicable to continuously bending a flexible device 200, so as to inspect a physical property in different curvatures. The flexible device 200 is clamped and bent by support members 206 and 208. The two support members 206, 208 are respectively disposed at two positions with a distance L in the lateral direction.

The flexible device, due to its own materiality, for instance, Young's module, will have a curvature at a bent position, for example, a bent tip 210. After being bent, it has a curvature. The radius of the curvature is represented by R. As such, the flexible device 200 is bent by a manner of being supported by the support members 206, 208 at predetermined positions, so as to generate a bent tip 210 with an intended curvature. The bent tip 210 is disposed at an inspection position O. In general, the intended curvature radius R of the flexible device 200 can be, for example, deduced from its own Young's module, thickness, and the distance between the support members 206, 208. However, this is not the only way. For example, the intended curvature radius R of the flexible device 200 can also be obtained by practically measuring the corresponding curvatures of the bent flexible device at different distances L, or can be obtained via direct measurement with a measurement unit 212 each time when bent. Moreover, the positions of the support members 206, 208 are adjusted in accordance with the required curvature radius R. It should be understood that, the mechanical member for constituting the support members 206, 208 and the flexible device 200 can be arranged according to above features and practical designs, and this can be understood by those ordinary skilled in the art and the illustration thereof is omitted herein. Likewise, the part related to the features of the invention is described, while others are omitted.

One or both of the aforementioned support members 206, 208 can be, for example, two supports clamping both surfaces of the flexible device 200. For example, the support member 206 has a support 206a and a support 206b clamping the internal and the external surface of the flexible device 200. The geometric structure of the support 206a and the support 206b is used for fixing the flexible device 200 at a predetermined position in Y direction, for generating a constant intended curvature. Therefore, there is no particular limitation to the geometric structure. However, for the convenience to control position, the support 206a at the external surface preferably is a structure attached to the external surface flatly.

Moreover, the flexible device 200 can also be, for example, wound around an output member 202, for instance, a roller. The output member 202 actively outputs the flexible device 200, and then passes it through the support member 206. After being bent, the flexible device 200 passes through the support member 208, and is received by the receiving member 204.

It should be noted that, the above-mentioned mechanism for transmitting the flexible device 200 can be integrated into a transmission system for transmitting the flexible device 200. In other words, any suitable transmission systems for transmitting the flexible device 200 can be modified based on practical requirements, thereby being integrated with the support members 206, 208. The structure detail of the transmission system can be completed according to the practical design mechanism, and this is appreciated by those skilled in the art and will be omitted herein.

Several embodiments with some design alterations are illustrated for the purpose of illustration, instead of limiting the invention.

FIG. 5 depicts the schematic structural top view of the apparatus for continuously bending a flexible device according to another embodiment of the invention. In FIG. 5, the support members 206, 208 can be, for example, rollers for clamping the flexible device 200. Furthermore, the arrangement of the transmission system can be illustrated by, for example, the support member 206, wherein the support member 206 includes an external roller 206a and an internal roller 206b. Besides, for the transmission system, the external roller 206a and the internal roller 206b of the support member 206 can be controlled to achieve the function of transmitting the flexible device 200. As such, the output member 202 and the receiving member 204 can have the transmission function, or can have a function just for collecting back the flexible device 200 without transmitting the flexible device 200. In other words, the transmission system can be arranged flexibly, and can be integrated with the support members 206, 208.

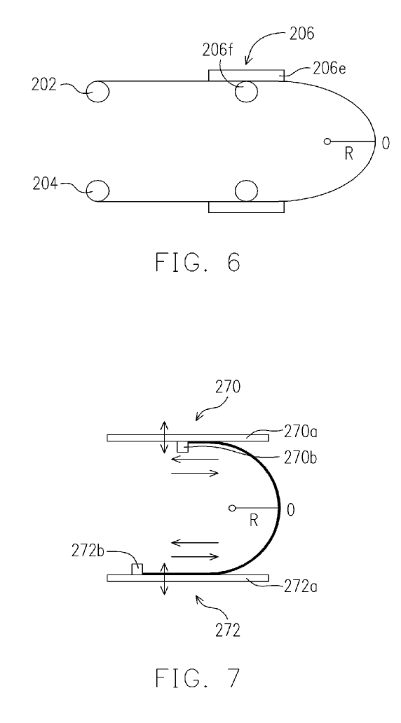

Further, FIG. 6 depicts the schematic structural top view of the apparatus for continuously bending a flexible device according to another embodiment of the invention. For example, the support member 206 can also be constituted by a flat external support 206e, and a roller internal support 206f. The external support 206e can provide a surface contacting with the external surface of the flexible device 200. Therefore, the curvature radius R of the bent tip can be easily controlled. Moreover, if the support members 206, 208 are provided with the function of transmitting the flexible device 200, the internal support 206f can, for example, transmit the flexible device 206 via a gear mechanism, as illustrated hereinafter. Also, as illustrated above, the output member 202 and the receiving member 204 can be arranged or not according to the practical demand, and meanwhile the driving force may exist or not.

Furthermore, FIG. 7 depicts the schematic structural top view of the apparatus for continuously bending a flexible device according to another embodiment of the invention. The support members 270, 272 can also be designed as a structure constituted by an external clamp 270a and an internal clamp 270b for clamping the flexible device 200 fixedly. However, the support members 270, 272 can be operated associating with a transmission system, for example, a slide rail, for moving the internal clamps 270b and 272b in longitudinal direction, so as to transmit the bent tip of the flexible device 200 passing the inspection position O. Of course, the support members 270, 272 can also be moved in lateral directions, for controlling the curvature radius R.

It should be noted that different designs can be made to the aforementioned embodiments, by adopting suitable corresponding parts and combining them together. Especially, the design of the transmission system and the integration with the support members can be varied according to actual designs. Moreover, the present invention is not limited to the illustrated embodiments.

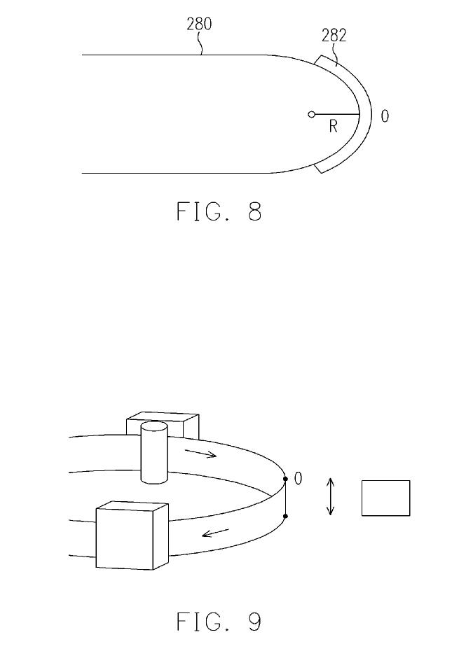

Also, FIG. 8 depicts the schematic structural top view of the apparatus for continuously bending a flexible device according to another embodiment of the invention. When the flexible device of the invention is a carrier 280, the inspected flexible device 282 can be attached to the carrier 280. As such, the flexible device 282 can be continuously bent at the inspection position O with the intended curvature radius R for a thorough inspection.

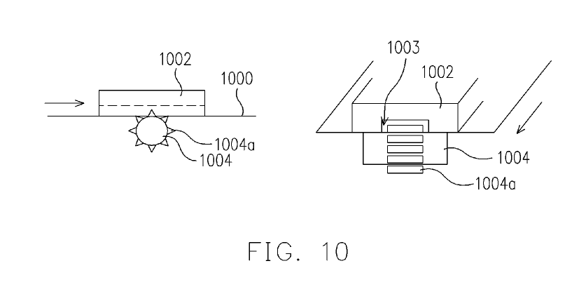

Additionally, FIG. 9 depicts the schematic stereogram of the structure of the apparatus for continuously bending a flexible device according to another embodiment of the invention. In FIG. 9, generally the flexible device is a stripe structure, for example, moving in an arrow direction to pass an inspection position O. The inspection position O is actually an inspection line. An inspection unit is represented by a block. The detector can be a 1D-optical detector or a charge-coupled detector (CCD), wherein the linear light source irradiates the inspection position, for linearly inspecting the inspection position O, and the flexible device is moved to fulfill a comprehensive inspection. In FIG. 9, the support members are, for example, similar to the structure in FIG. 6.

FIG. 10 depicts the schematic structural view of the support member according to another embodiment of the invention. In FIG. 10, the left part is a schematic sectional view of the advancing direction of the flexible device, for example, indicated by an arrow. And the right part is a schematic sectional view perpendicular to the advancing direction of the flexible device, for example, indicated by an arrow.

In FIG. 10, a clamp 1002, for example, has a contact surface with a flexible device 1000, while another clamp 1004 is, for example, a roller designed with a gear part 1004a. The gear part 1004a can pass through the holes in the flexible device, for driving the flexible device. The clamp 1002 can also be, for example, fitted with the mechanism of the gear part 1004a designed with a groove 1003. The design of the clamp can be modified by integrated with the transmission system mechanism. The transmission system can also, for example, use a motor to provide the driving force.

The structural design of the apparatus has been illustrated above. However, as the practical structure of the design has various alterations, the illustrated embodiments are only the preferred ones. Besides, for the implementation of the embodiment, several steps can be concluded according to the invention. Taking FIG. 4 as an example, the flexible device 200 is bent to generate an intended curvature (curvature radius R) at a position, for example a bent tip 210 at an inspection position O. Then, the flexible device 200 is moved to make at least one portion of the flexible device 200 pass the inspection position O with the intended curvature. As for the implementation details under the principle, the designs can be varied based on actual demands without departing from the spirit and scope of the invention.

The method and apparatus for continuously bending a flexible device adopt two support members at corresponding positions to generate an intended curvature. Then, a flexible mechanism design is adopted to transmit the flexible device, so as to have capability to inspect a physical property of the flexible device concerning curvature in a comprehensive and simple way.

The present invention is especially applicable to inspecting flexible display devices, reducing the process and saving the expenses. In addition, it can effectively save the fabricating cost and the fabricating time. The applicable fields of the product can be obtained in the phase of research and development. Or the material can be evaluated by the property of the functional film in different curvatures.

Though the present invention has been disclosed above by the preferred embodiments, it is not intended to limit the invention. Anybody skilled in the art can make some modifications and variations without departing from the spirit and scope of the invention. Therefore, the protecting range of the invention falls in the appended claims.

What is claimed is:

1. A method for continuously bending a flexible device, suitable for continuously bending a flexible device, so as to inspect a physical property in different curvature, comprising:
bending the flexible device to generate a bent position with an intended curvature at an inspection position; and
moving the flexible device, for making at least one portion of the flexible device pass the inspection position with the intended curvature.

2. The method for continuously bending a flexible device according to claim 1, wherein the intended curvature is deduced from a material property and geometrical and physical quantities, or obtained from a look-up table, or a direct measurement.

3. The method for continuously bending a flexible device according to claim 1, wherein the step of moving the flexible device comprises respectively fixing both ends of the flexible device at two supports on different support members, two supports capable of moving in a opposite direction.

4. The method for continuously bending a flexible device according to claim 1, wherein the step of moving the flexible device comprises disposing an output member for continuously outputting the flexible device in a direction towards the inspection position and a receiving member for continuously receiving the bent flexible device.

5. The method for continuously bending a flexible device according to claim 1, wherein the step of bending the flexible device comprises:
adopting a first support member and a second support member, respectively disposed at a first position and a second position, for clamping and bending the flexible device.

6. The method for continuously bending a flexible device according to claim 5, wherein a transmission mechanism is further disposed on the first and second support members, provided with the function of transmitting the flexible device.

7. The method for continuously bending a flexible device according to claim 6, wherein the transmission mechanism drives the flexible device by a roller, a geared roller, or a slide rail.

8. The method for continuously bending a flexible device according to claim 5, wherein the flexible device is bent with the intended curvature by moving the first and second support members in the lateral directions, the intended curvature being adjusted along with the distance between the two support members.

9. The method for continuously bending a flexible device according to claim 1, wherein the flexible device is an inspected device or a carrier for holding the inspected device.

10. An apparatus for continuously bending a flexible device, suitable for continuously bending a flexible device to inspect a physical property in different curvatures, comprising:
a first support member, disposed at a first position;
a second support member, disposed at a second position, wherein the flexible device is bent to generate a bent position with an intended curvature at an inspection position by the support of the first and second support members according to the first position, the second position, and a material property of the flexible device; and
a transmission system, for continuously moving the flexible device to make at least one portion of the flexible device pass the inspection position with the intended curvature.

11. The apparatus for continuously bending a flexible device according to claim 10, further comprising a measurement unit, for directly measuring the curvature of the flexible device.

12. The apparatus for continuously bending a flexible device according to claim 10, wherein the transmission system comprises:
an output member, for continuously outputting the flexible device in a first direction towards the inspection position; and
a receiving member, for continuously receiving the output flexible device in a second direction, wherein the first direction is parallel and opposite to the second direction.

13. The apparatus for continuously bending a flexible device according to claim 10, wherein at least one of the first support member or the second support member supports the flexible device by clamping both surfaces of the flexible device in a first clamp and a second clamp.

14. The apparatus for continuously bending a flexible device according to claim 10, wherein at least one of the first support member or the second support member comprises a surface for contacting with the flexible device.

15. The apparatus for continuously bending a flexible device according to claim 10, wherein at least one of the first or second support members comprises at least one roller or gear, for supporting the flexible device.

16. The apparatus for continuously bending a flexible device according to claim 10, wherein at least one of the first support member or the second support member comprises at least one roller or gear integrated with the transmission system, provided with the function of transmitting the flexible device.

17. The apparatus for continuously bending a flexible device according to claim 16, wherein the flexible device is transmitted by a slide rail, a gear mechanism, or a motor.

18. The apparatus for continuously bending a flexible device according to claim 10, wherein the two support members and the transmission system for respectively moving the supports on the two support members are arranged to respectively fix both ends of the flexible device on two supports of the two different support members, and move the two supports in relative opposite directions.

19. The apparatus for continuously bending a flexible device according to claim 10, wherein the first and second positions of the first and second support members are adjustable in lateral directions in accordance with the intended curvature.

20. The apparatus for continuously bending a flexible device according to claim 10, wherein the flexible device is an inspected device or a carrier for holding an inspected device.
